(19) United States
(12) Patent Application Publication
(10) Pub. No.: US 2008/0282146 A1
(43) Pub. Date: Nov. 13, 2008

(54) TEXT DISPLAY DEVICE

(76) Inventor: WALEED NEMA, OAK CREEK, WI (US)

Correspondence Address: DYKAS, SHAVER & NIPPER, LLP, P.O. BOX 877, BOISE, ID, 83701-0877, US

(21) Appl. No.: 11/745,960

(22) Filed: May 8, 2007

(51) Int. Cl. G06F 17/00; G06F 3/048

(52) U.S. Cl. 715/246; 715/251; 715/781

(57) ABSTRACT

Presented is a device for aiding in reading comprehension which includes a display unit with a first position and a second position. The most recently read text is typically displayed on the right hand side of the display unit and the recently read text is displayed on the left hand page.

### FIELD OF THE INVENTION

The present invention generally relates to an apparatus for displaying text to be read, and more particularly to device for displaying two pages simultaneously.

### BACKGROUND OF THE INVENTION

The device is a reading device and more particularly a reading device for displaying two pages of text simultaneously. Reading is an essential and fundamental skill in western culture. Many devices have been utilized to assist people in reading and any improvement which adds and or comprehension is a very useful tool. Reading skills are widespread and essential to everyday life including education, in the workplace, and for entertainment.

Books have been a standard format for conveying information for many centuries. In our culture a person reads from the top of the page to the bottom of the page, and from left to right on each line, starting with the left page. When reading a book if one opens the book and begins reading the information on the left hand side of the two exposed pages he would read down that page until he reached the bottom, and then he would begin reading at the top of the right hand page. Studies have shown that when reading the right hand page the reader has an advantage in comprehending the text he is reading by having the text he has most recently read being exposed and readable on the left hand side. Thus when he comes to some information which makes him want to double check what he has previously read, he can quickly do so, verify the information and move on. By contrast if he is reading the left hand page of the two exposed pages, if he wants to verify information he has to flip the back page over and scan down the previous right page with his eyes to find it. Since this has been the standard format for centuries, no one gave any thought to an improved method of displaying text for reading, because with material printed on paper and bound into books, there is really no other way to display the information.

With advent of digital technology and electronic display of information, the methodology of reading can be improved. What is needed is a device which displays two pages of text, just like is displayed in a book. However, in an electronic format the two pages which are displayed can always be the most recently read page and the page currently being read. This display style is totally lacking in the prior art and a device which accomplishes this would be desirable.

### SUMMARY OF THE INVENTION

The current invention addresses these problems and solves them in a unique way. The device is a text reading device which includes a text display area for displaying text. The text is displayed in a two page format in which a first page and second page simultaneously display on the display area. The device includes an information retrieval system, and stored information. The information retrieval system can be an electronic means such as a hard drive, a thumb disk, a disk with flash memory, or other types of stored electronic media. The retrieval system would be a system which is able to read this media, retrieve selected information, and display it on the display area.

The text writing device of the invention includes a page advance function, which moves the text being displayed between the two pages that are displayed. The first and second pages of text are displayed on the text display in a first and second position. One page of text is the text in which the reader has most recently read. The other page of text is the text that the reader is currently reading. The page advance function would typically be a button or other input device which is utilized by the user to indicate to the device to advance a page. The reading device is configured so that the text currently being read is always displayed in the first position on the display area, and the most recently read page is always displayed on the second position. The advancing of the text from one position to another is controlled by the user activating the page advance function.

One configuration of this device is to have the first position and the second position displayed side by side on the display area. The first position would be on the right and the second position would be on the left. In this configuration the text which is currently being read is in the first position, which is on the right, the text which has most recently been read is in the second position which is on the left. In this way the reader can proceed down the page of text that he is reading with it displayed on the right hand side of the display. At the same time the most recently read text is displayed in the second position which is on the left hand side of the display area. Thus while the reader is reading new text he can refer to the text most recently read to check information or clarify what he is currently reading.

Other configurations of this device are possible, and would be especially useful for users reading a language right to left, or top to bottom or bottom to top. In each of these languages texts could be displayed in two pages with a first and second position, with the first position being the currently read text, and the second position being the most recently read text. The device could also be configured so that the user may configure the page display, and set it to landscape or portrait format and with his choice of text in the first and second position. His choice can be currently read text, the text most recently read, or a page of text which is the next text to be read.

The reading device of the invention, besides working with stored memory such as CD's, DVD's, thumb drives, flash memory, or other electronic media, can also be configured to operate with various wireless technologies such as infrared, wireless internet, Bluetooth, etc.

The device can be built as a stand alone unit, much like a laptop or notebook computer. It can also be configured to be a computer based device with software for operating the device utilized by the computer, and with the text display area being shown on a computer display. The page advance function would typically be by the user manually pressing a button or another control to advance the text. A back button would also be available so that the user could back up the text to pages he had previously read. When the device is incorporated into a computer format, the advance and back buttons could be operated by mouse or by touching a touch screen. The advance button could be activated by sound, such as the user saying “advance” or “back” as appropriate.

The purpose of the foregoing Abstract is to enable the public, and especially the scientists, engineers, and practitioners in the art who are not familiar with patent or legal terms or phraseology, to determine quickly from a cursory inspection, the nature and essence of the technical disclosure of the application. The Abstract is neither intended to define the invention of the application, which is measured by the claims, nor is it intended to be limiting as to the scope of the invention in any way.

Still other features and advantages of the present invention will become readily apparent to those skilled in this art from the following detailed description describing preferred embodiments of the invention, simply by way of illustration of the best mode contemplated by carrying out the invention. As will be realized, the invention is capable of modification in various obvious respects all without departing from the invention. Accordingly, the drawings and description of the preferred embodiments are to be regarded as illustrative in nature, and not as restrictive in nature.

### BRIEF DESCRIPTION OF THE DRAWINGS

FIG. 1 is a perspective view of the reading device of the invention.

FIG. 2 is a perspective view of the reading device of the invention when utilized with a computer.

### DESCRIPTION OF THE PREFERRED EMBODIMENTS

While the invention is susceptible to various modifications and alternative constructions, certain illustrated embodiments thereof have been shown in the drawings and will be described below in detail. It should be understood, however, that there is no intention to limit the invention to the specific form disclosed, but, on the contrary, the invention is to cover all modifications, alternative constructions, and equivalents falling within the spirit and scope of the invention as defined in the claims.

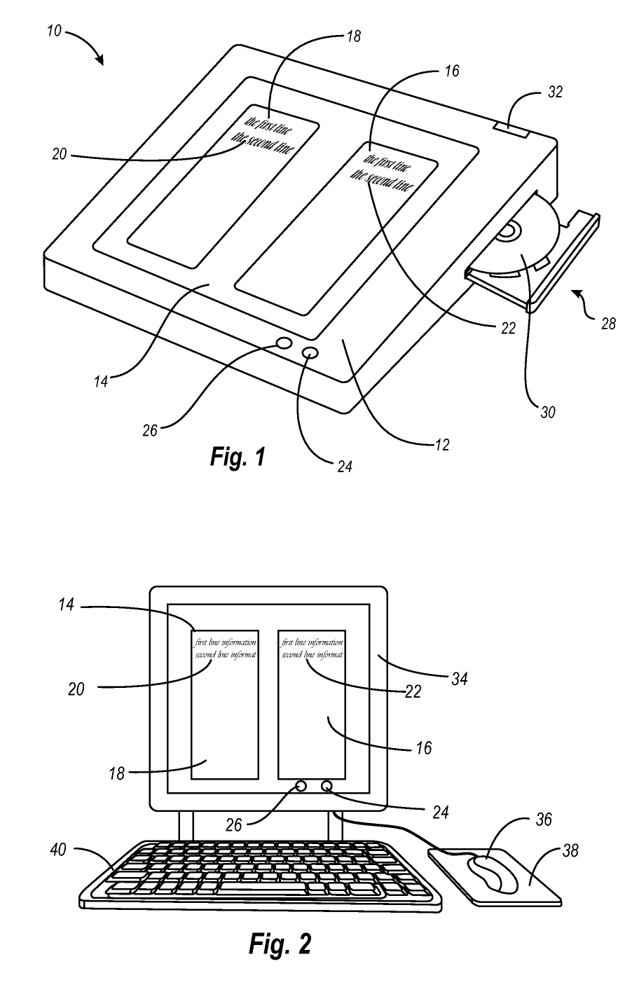

FIGS. 1 and 2 show the invention in two different forms.

FIG. 1 shows a stand alone device as a version of the reading device 10 of the invention. The reading device 10 can take a number of configurations including the stand alone version in FIG. 1. The embodiment shown in FIG. 1 includes a device body 12 which houses the components of the reading device 10. The reading device 10 includes a display area 14 which would typically be an electronic display area for display of information such as text. The display area includes a first position 16 and a second position 18. Within the first and second positions 16 and 18 are display text. The text which is currently being read is designated as 22, and the reader would begin at the top of this text and end at the bottom. When he reaches the bottom of the currently read text 22, he would press the advance button 24 to move the recently read text into the second position 18. Thus the second position 18 will always display recently read text 20, and the first position 16 will always display the text that is currently being read 22.

In addition to an advance button 24, a back button 26, is provided. Each of these buttons can obviously take a number of different forms, and can be incorporated into a touch screen or can be modified to be voice activated.

The device includes media on which text information is stored, as exemplified by storage media 28 in which a CD 30 is displayed. Other storage media can also be utilized such as DVD's, flash media, thumb drive, or other types of electronic stored media. The device can also operate with wireless technology such as inferred, Bluetooth, or wireless internet. A wireless port 32 is shown which would be utilized with certain types of wireless technologies.

FIG. 2 shows the same components when the device is incorporated into a program which is run on a computer. The same first position and second position are present, including an advance button 24 and back button 26. The computer shown includes a keyboard 40, a mouse 36 and a mouse pad 38. In this configuration the advance and back buttons 24 and 26 can be activated by the use of the mouse 36, or depending on the computer or it may be activated by the use of the touch screen. Voice activation in the computer mode is also possible.

The exemplary embodiments shown in the figures and described above illustrate but do not limit the invention. It should be understood that there is no intention to limit the invention to the specific form disclosed; rather, the invention is to cover all modifications, alternative constructions, and equivalents falling within the spirit and scope of the invention as defined in the claims. Hence, the foregoing description should not be construed to limit the scope of the invention, which is defined in the following claims.

While there is shown and described the present preferred embodiment of the invention, it is to be distinctly understood that this invention is not limited thereto, but may be variously embodied to practice within the scope of the following claims. From the foregoing description, it will be apparent that various changes may be made without departing from the spirit and scope of the invention as defined by the following claims.

What is claimed is:

1. A text reading device comprising:
a text display area for displaying text in a two page format, with a first and a second page of text displayed simultaneously;
information retrieval system, for retrieval of selected information;
a page advance function, for moving a recently read page from the first position to the second position, so that the most recently read page is shown in the second position, and for displaying a currently read page on the first position; wherein
the reading device is configured so that the currently read page is always displayed in the first position, with the most recently read page always displayed in the second position.

2. A text reading device comprising:
a text display area for displaying text in a two page format, with a left and a right page of text displayed simultaneously;
information retrieval system, for retrieval of selected information;
a page advance function, for moving the recently read page from the right position to the left position, so that the currently read page is shown on the right, and for displaying an unread page on the right position; wherein
the reading device is configured so that the currently read page is always displayed on the right page, with the most recently read page always displayed on the left page.

3. A text reading device comprising: change to left to right version
a text display area for displaying text in a two page format, with a left and a right page of text displayed simultaneously;
information retrieval system, for retrieval of selected information;
a page advance function, for moving the recently read page from the left position to the right position, so that the currently read page is shown on the left, and for displaying an unread page on the right position; wherein
the reading device is configured so that the currently read page is always displayed on the left page, with the most recently read page always displayed on the right page.

4. The reading device of claim 1 in which said device is computer based, with said text display area being shown on a computer display.

5. The reading device of claim 1 in which said device is a standalone unit, with said text display area being shown on a display screen.

6. The reading device of claim 1 in which said page advance function is user activated.

7. The reading device of claim 6 in which said page advance function is a page advance button.

8. The reading device of claim 7 wherein said page advance button is located on the device

9. The reading device of claim 7 wherein said page advance button is located on-screen and is activated by a computer operated mouse or other pointing device

10. The reading device of claim 7 wherein said page advance button is located on-screen and is activated by touch on a touch screen.

11. The reading device of claim 6 wherein said page advance function is activated by sound or other non-tactile but user controlled signaling.

12. The said reading device of claim 1 which said data retrieval system is comprised of a swappable media such as a dvd, cd, flash memory

13. The reading device of claim 1 in which said data retrieval system is internally located and synced with an external data source.

14. The reading device of claim 1 in which said data retrieval system is received by electromagnetic distribution.
